(19) United States
(12) Patent Application Publication
(10) Pub. No.: US 2007/0264064 A1
(43) Pub. Date: Nov. 15, 2007

(54) Image Forming Apparatus and Method of Controlling the Apparatus

(75) Inventors: Yusuke Hashizume, Urayasu-shi (JP); Naoaki Ide, Shizuoka-shi (JP); Hirokazu Shoda, Yokohama-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/383,428

(22) Filed: May 15, 2006

(51) Int. Cl. G03G 15/00

(52) U.S. Cl. 399/376

(57) ABSTRACT

Black tapes 61 and 62 having optical reflectances different from that of the texture of a document D are stuck to the lower side of a platen cover 3. The black tapes 61 and 62 have the optical reflectances different from that of the texture of the document D. When the document D set on a document table 2 and the black tapes 61 and 62 are exposed by a light exposure lamp 5, at least one edge of the document D set on the document table 2 and the length of the edge are detected according to the amount of reflected light from the document D and that from the black tapes 61 and 62. The size of the document D set on the document table 2 is judged according to the detected length of the edge.

### BACKGROUND OF THE INVENTION

In an image forming apparatus such as a copying machine, a light exposure lamp is reciprocated along a document table on which a document is placed so that an image of the document is optically read, and the read image is formed on a paper sheet.

The image forming apparatus as stated above contains plural kinds of paper sheets different in size. One paper sheet corresponding to the size of the document is taken out from these paper sheets. The size of the document is detected by four or five photosensors provided at the lower side of the document table.

In order to detect the size of the document, the four or five expensive photosensors must be used, and there is a problem that cost is increased.

### BRIEF SUMMARY OF THE INVENTION

An object of the invention is to provide an image forming apparatus which can inexpensively and accurately detect the size of a document without using an expensive photosensor.

An image forming apparatus according to an aspect of the invention includes

a document table on which a document is to be set,

a cover to press the document set on the document table,

a member provided on the cover and having optical reflectance different from that of texture of the document,

a light exposure section to expose the document set on the document table and the member,

a detection section to detect at least one edge of the document set on the document table and a length of the edge according to an amount of reflected light from the document and the member at a time of the light exposure, and

a judgment section to judge a size of the document set on the document table according to a detection result of the detection section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the outer appearance of each of embodiments.

FIG. 2 is a view showing the structure of the inside of each of the embodiments.

FIG. 3 is a view showing the structure of a document table and its peripheral part of a first embodiment.

FIG. 4 is a view showing the structure of a light exposure lamp and its peripheral part of each of the embodiments.

FIG. 5 is a block diagram of a control circuit of each of the embodiments.

FIG. 6 is a flowchart for explaining the total operation of each of the embodiment.

FIG. 7 is a view showing a state in which a document is set on a document table of each of the embodiments.

FIG. 8 is a view showing a state in which respective black members of the first embodiment cover the document table and the document.

FIG. 9 is a view of FIG. 8 seen from the lower side of the document table.

FIG. 10 is a flowchart for explaining a detection processing of a document size in the first embodiment.

FIG. 11 is a view showing the structure of a document table and its peripheral part of a second embodiment.

FIG. 12 is a view showing a state in which respective black members of the second embodiment cover the document table and a document.

FIG. 13 is a flowchart for explaining a detection processing of a document size in the second embodiment.

### DETAILED DESCRIPTION OF THE INVENTION

Hereinafter, a first embodiment of the invention will be described with reference to the drawings.

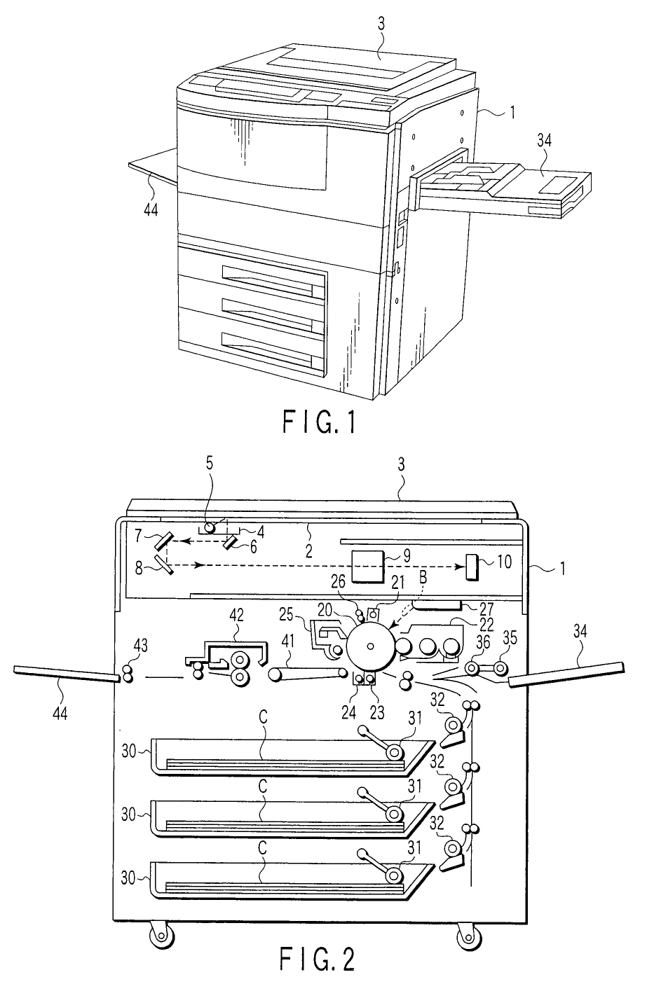

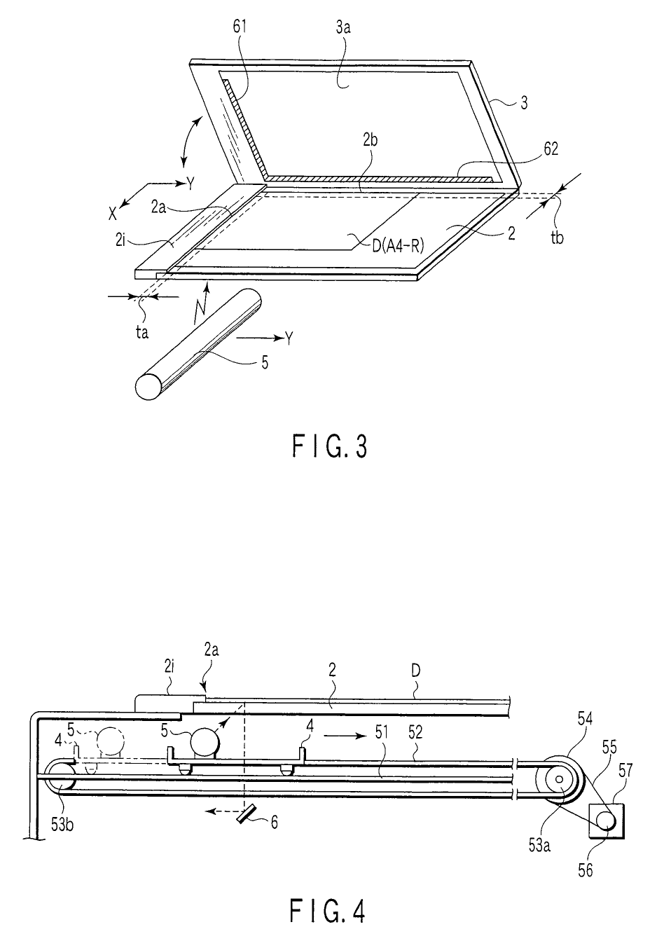

As shown in FIG. 1 and FIG. 2, a transparent document table (glass plate) 2 for document setting is provided at the upper part of a body 1, and a platen cover 3 is openably/closably provided on the document table 2. Besides, as shown in FIG. 3, an indicator part 2i is provided along an edge 2a of the document table 2. A rectangular portion formed of the indicator section 2i and an edge 2b of the document table 2 is a reference position for document setting. A document D is set in conformity with the reference position.

A carriage 4 is provided at the lower side of the document table 2, and a light exposure lamp 5 is provided in the carriage 4. A light exposure section (light exposure means) includes the carriage 4 and the light exposure lamp 5. The carriage 4 can reciprocate along the lower surface of the document table 2. The light exposure lamp 5 is turned on while the carriage 4 reciprocates, so that the document D placed on the document table 2 is exposed to light.

A reflected light image of the document D placed on the document table 2 is obtained by this light exposure, and that is projected onto image signal output means, for example, a CCD (Charge Coupled Device) 10 through reflection mirrors 6, 7 and 8 and a lens block 9 for variable power. The CCD 10 outputs a signal with a voltage level corresponding to the amount of received light.

A scanner to optically read the document D placed on the document table 2 includes the carriage 4, the light exposure lamp 5, the reflection mirrors 6, 7 and 8, the lens block 9 for variable power and the CCD 10. The document D placed on the document table 2 is subjected optically to main scanning in one direction, and the main scanning is repeated according to the forward movement of the light exposure lamp 5. The repetition of the main scanning according to the forward movement of the light exposure lamp 5 is called sub-scanning. In FIG. 3, the direction of the main scanning is indicated by X, and the direction of the sub-scanning is indicated by Y.

As a member having optical reflectance different from that of the texture of the document D, a black tape 61 as a band-like first black member and a black tape 62 as a band-like second black member are stuck to a lower surface (surface coming in contact with the document table 2 and the document D) 3a of the platen cover 3. The black tape 61 has almost the same length as the edge 2a of the document table 2, and faces a band-like first read ineffective area having a constant width ta along the edge 2a. The black tape 62 has almost the same length as the edge 2b of the document table 2, and faces a band-like second read ineffective area having a constant width tb along the edge 2b. These read ineffective areas are called also voids.

When the platen cover 3 is closed, the black tape 61 overlaps with almost the whole area of the first read ineffective area having the constant width ta along the edge 2a of the document table 2, and the black tape 62 overlaps with almost the whole area of the second read ineffective area having the constant width tb along the edge 2b of the document table 2.

An image signal outputted from the CCD 10 is amplified and converted into a digital signal, and the digital signal is processed by an after-mentioned image processing part 74, and then is supplied to a laser unit 27. The laser unit 27 emits a laser beam B corresponding to the input signal.

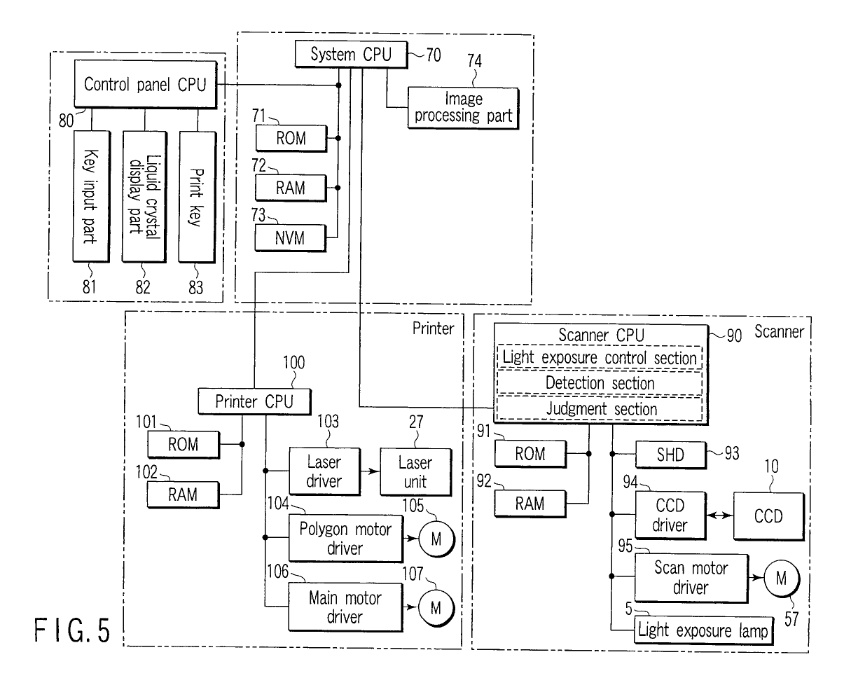

As shown in FIG. 4, the carriage 4 is movably mounted on a rail 51. A wire 52 is coupled to the carriage 4, and the wire 52 is stretched over a drive pulley 53a and a driven pulley 53b The drive pulley 53a is coupled to a reduction pulley 54, and the reduction pulley 54 is coupled to a pulley 56 of a scan motor 57 through a timing belt 55. A pulse motor is used as the scan motor 57. The movement position of the carriage 4 is managed by the supply number (step number) of drive voltage pulses to the scan motor 57.

On the other hand, a photosensitive drum 20 is rotatably provided at substantially the center in the body 1. A charging unit 21, a developing unit 22, a transfer unit 23, a peeling unit 24, a cleaner 25 and a charge-removable unit 26 are successively provided around the photosensitive drum 20. The laser beam B emitted from the laser unit 27 is irradiated onto the surface of the photosensitive drum 20 through between the charging unit 21 and the developing unit 22.

Plural cassettes 30 are provided at the bottom in the body 1. Many paper sheets C with sizes different from each other are contained in these cassettes 30. When an after-mentioned print key 83 is turned on, the paper sheet C is taken out one by one from one of the cassettes 30. A pickup roller 31 for taking out is provided for each of the cassettes 30. The taken-out paper sheet C is separated from the cassette 30 by a separation unit 32 and is sent to a register roller 33. The register roller 33 feeds the paper sheet C to between the photosensitive drum 20 and the transfer unit 23 at a timing in view of the rotation of the photosensitive drum 20.

The charging unit 21 applies a high voltage to the photosensitive drum 20, so that the surface of the photosensitive drum 20 is charged with static electricity. The laser beam B emitted from the laser unit 27 is irradiated to the surface of the photosensitive drum 20 which has been charged. The laser unit 27 performs main scanning of the surface of the photosensitive drum 20 in one direction, and performs sub-scanning to repeat the main scanning according to the rotation of the photosensitive drum 20, so that an electrostatic latent image corresponding to the image read by the scanner is formed on the surface of the photosensitive drum 20.

The electrostatic latent image formed on the photosensitive drum 20 receives a developer (toner) from the developing unit 22, so that the image is revealed. This revealed image is transferred onto the paper sheet C by the transfer unit 23. The paper sheet C on which the transfer has been completed is peeled off from the photosensitive drum 20 by the peeling unit 24. The developer and electric charge remain on the surface of the photosensitive drum 20 from which the paper sheet C is peeled off. The remaining developer is removed by the cleaner 25. The remaining electric charge is removed by the charge-removal unit 28.

The paper sheet C peeled from the photosensitive drum 20 is sent to a fixing unit 42 by a transport belt 41. The fixing unit 42 fixes the image transferred on the paper sheet C by heat. The paper sheet C in which the fixing is ended is discharged to a tray 44 by a paper discharge roller 43.

A printer to print the image read by the scanner onto the paper sheet C is constructed by the structure from the photosensitive drum 20 to the tray 44.

FIG. 5 shows a total control circuit.

A system CPU 70, a control panel CPU 80, a scanner CPU 90 and a printer CPU 100 are mutually connected. The system CPU 70 totally controls the control panel CPU 80, the scanner CPU 90, and the printer CPU 100.

Further, a ROM 71 for control program storage, a RAM 72 for data storage, an NVM 73, and an image processing part 74 are connected to the system CPU 70.

A key input part 81, a liquid crystal display part 82, and a print key 83 are connected to the control panel CPU 80. The key input part 81 includes a power switch, a document size designation key, a magnification designation key and the like. The liquid crystal display part 82 displays information corresponding to the operation of the key input part 81 and various informations to be notified to the user.

A ROM 91 for control program storage, a RAM 92 for data storage, a shading correction part (SHD) 93, a CCD driver 94, a scan motor driver 95, and the light exposure lamp 5 are connected to the scanner CPU 90. The CCD driver 94 drives the CCD 10. The scan motor driver 95 drives the scan motor 57.

A ROM 101 for control program storage, a RAM 102 for data storage, a laser driver 103, a polygon motor driver 104, and a main motor driver 106 are connected to the printer CPU 100. The laser driver 103 drives the laser unit 27. The polygon motor driver 104 drives a polygon motor as a drive source of a polygon mirror to scan the laser beam B relative to the photosensitive drum 20. The main motor driver 106 drives a main motor 107 as a drive source of the photosensitive drum 20, the sheet transport mechanism and the like.

The scanner CPU 90 includes following sections (1) to (3) as main functions.

(1) A light exposure control section to control light exposure by the light exposure section.

(2) A detection section to detect at least one edge of the document D set on the document table 2 and the length of the edge according to the amount of reflected light from the document D and the black tapes 61 and 62 at the time of the light exposure.

Specifically, at least one edge of the document D set on the document table 2 and the length of the edge are detected according to the difference between the amount of reflected light from the document D and the amount of reflected light from the black tapes 61 and 62 at the time of the light exposure.

(3) A judgment section to judge the size of the document D set on the document table 2 according to the length of the edge detected by the detection section.

Next, the operation will be described.

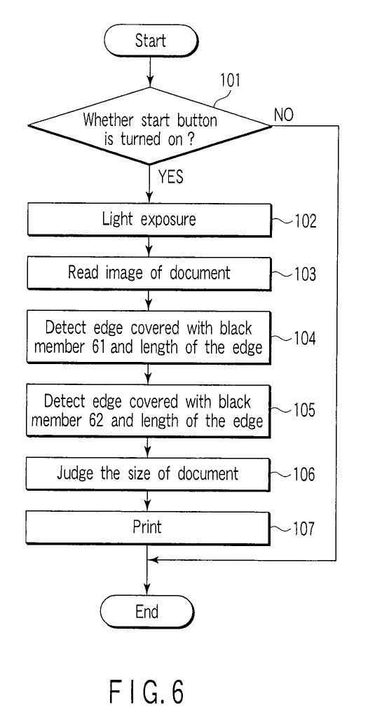

First, as shown in a flowchart of FIG. 6, when a start button of a control panel of the body 1 is turned on (YES at step 101), the document table 2 and the document D set on the document table 2 are exposed to light (step 102). The image of the document D is read by this light exposure (step 103).

Besides, with the light exposure, among four edges of the document D set on the document table 2, an edge covered with the black tape 61 and the length of the edge are detected (step 104), and an edge covered with the black tape 62 and the length of the edge are detected (step 105).

The size of the document D set on the document table 2 is judged according to at least the one edge and the length of the edge detected as stated above (step 106). Based on this judgment result, one paper sheet of a specified size is taken out from the cassette 30. The read image is printed on the taken-out paper sheet (step 107).

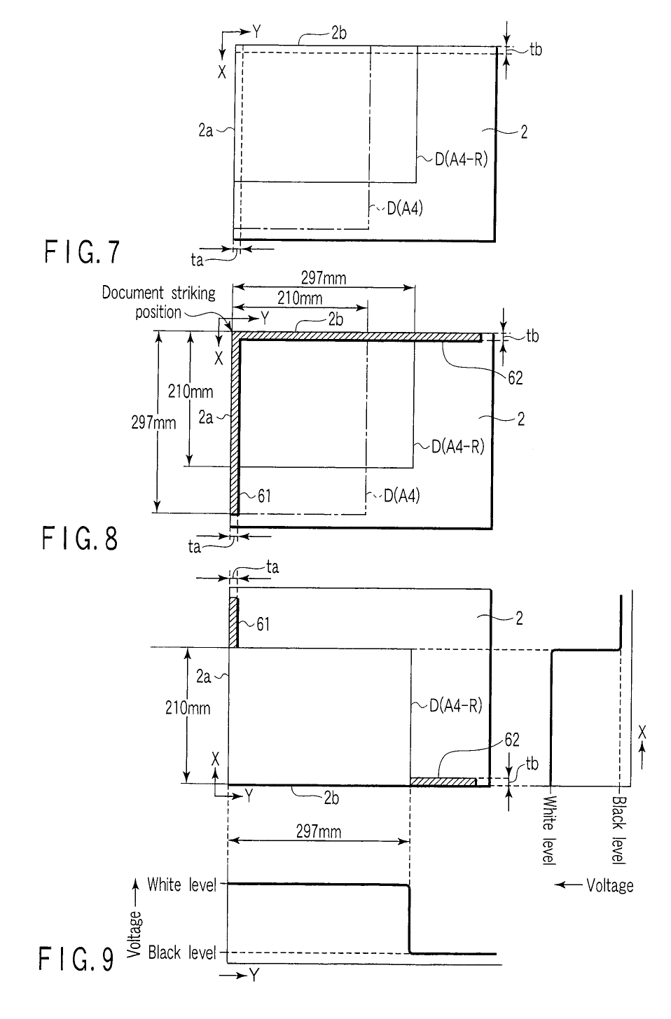

FIG. 7 shows a state in which the document D of, for example, “A4-R” size is set on the document table 2. In this state, when the platen cover 3 is closed, as shown in FIG. 8, the black tape 61 covers the whole area of the read ineffective area having a constant width ta along the edge 2a of the document table 2, and the black tape 62 covers the whole area of the read ineffective area having a constant width tb along the edge 2b of the document table 2. FIG. 9 shows this state seen from the lower side (light exposure lamp 5 side) of the document table 2.

That is, when the document table 2 is seen from its lower side, one edge of the document D and a part of the black tape 61 exist in the read ineffective area having the constant width ta along the edge 2a of the document table 2. Besides, one edge of the document D and a part of the black tape 62 exist in the read ineffective area having the constant width tb along the edge 2b of the document table 2.

In the read ineffective area having the constant width ta along the edge 2a of the document table 2, the edge of the document D has high optical reflectance, and the black tape 61 has low optical reflectance. Similarly, in the read ineffective area having the constant width tb along the edge 2b of the document table 2, the edge of the document D has high optical reflectance, and the black tape 62 has low optical reflectance.

Accordingly, when the read ineffective area having the constant width ta along the edge 2a of the document table 2 is exposed by the light exposure lamp 5, the amount of reflected light from the edge of the document D is large, and the voltage level of the signal outputted from the CCD 10 becomes high (white level). The amount of reflected light from the black tape 61 is small, and the voltage level of the signal outputted from the CCD 10 becomes low (black level). Based on the difference between both the voltage levels, among four edges of the document D set on the document table 2, the edge covered with the black tape 61 and the length (210 mm) of the edge are detected.

Similarly, when the read ineffective area having the constant width tb along the edge 2b of the document table 2 is exposed by the light exposure lamp 5, the amount of reflected light from the edge of the document D in the longitudinal direction is large, and the voltage level of the signal outputted from the CCD 10 becomes high (white level). The amount of reflected light from the black tape 62 is small, and the voltage level of the signal outputted from the CCD 10 becomes low (black level). Based on the difference between both the voltage levels, among four edges of the document D set on the document table 2, the edge covered with the black tape 62 and the length (297 mm) of the edge are detected.

As indicated by alternate long and shot dash lines in FIG. 7 and FIG. 8, in the case where the document D of “A4” size is set on the document table 2, when the read ineffective area having the constant width ta along the edge 2a of the document table 2 is exposed by the light exposure lamp 5, among four edges of the document D set on the document table 2, an edge covered with the black tape 61 and the length (297 mm) of the edge are detected, and an edge covered with the black tape 62 and the length (210 mm) of the edge are detected.

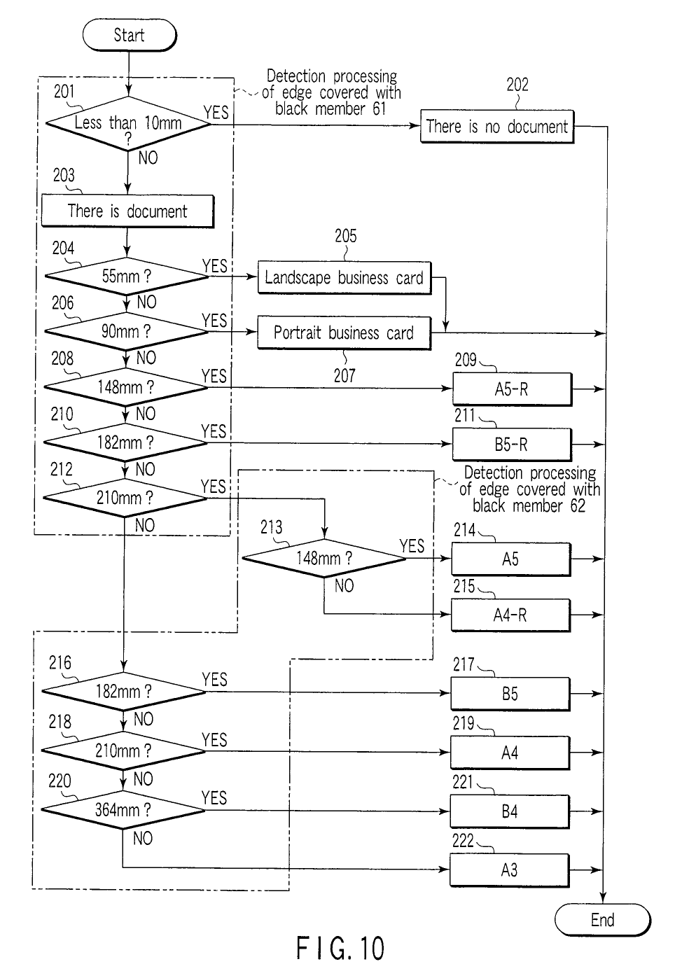

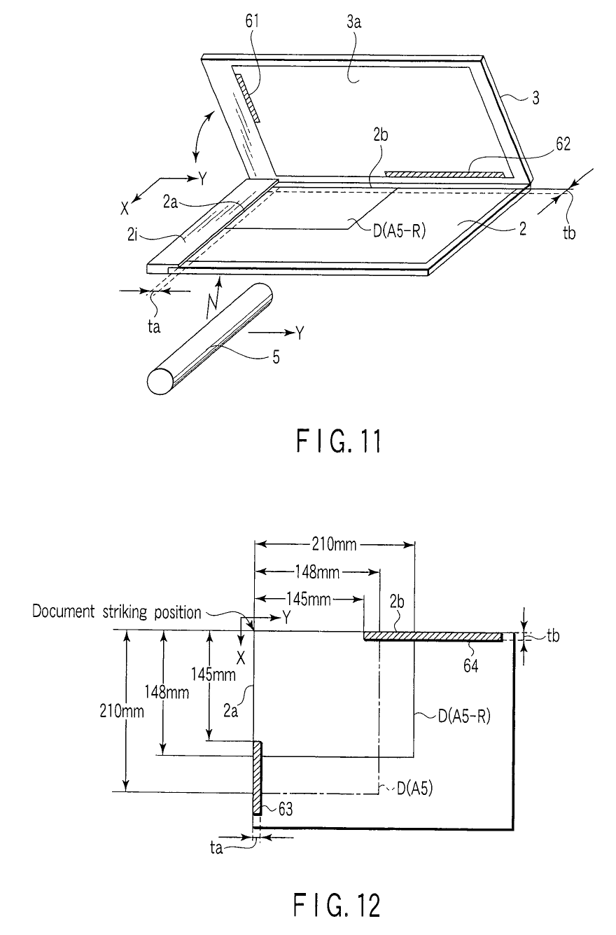

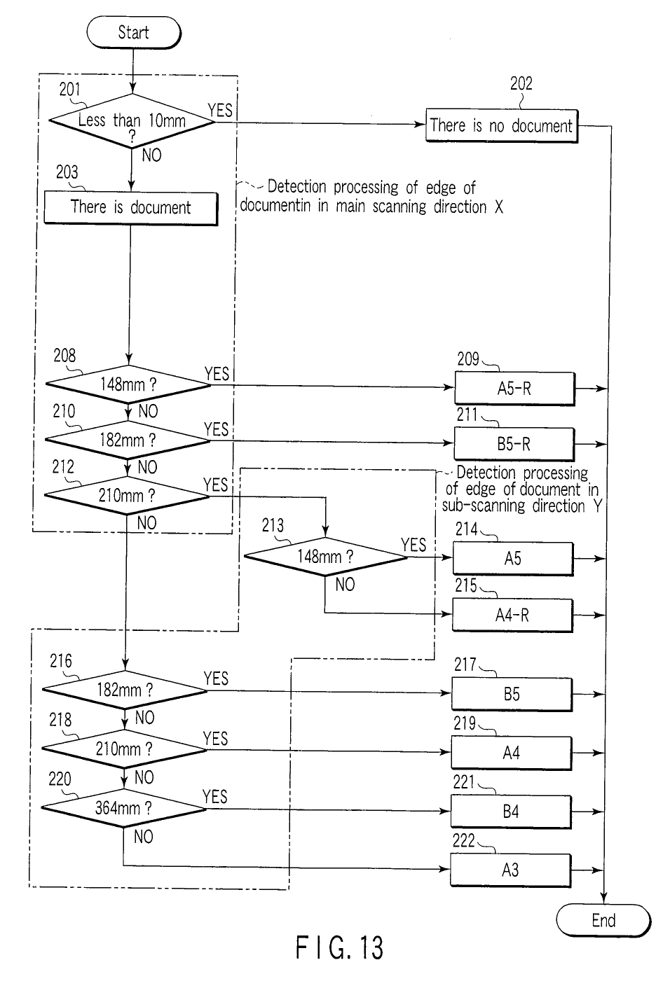

The detection processing of the document size is shown in a flowchart of FIG. 10.

First, a detection processing of an edge covered with the black tape 61 is executed. That is, in the detection processing of the edge covered with the black tape 61, when a length of less than 10 mm is detected (YES at step 201), it is judged that there is no document (step 202). When a length of 10 mm or more is detected (NO at step 201), it is judged that there is a document (step 203).

When a length of 55 mm is detected (YES at step 204), it is judged that the document D is a landscape business card (step 205). When a length of 90 mm is detected (YES at step 206), it is judged that the document D is a portrait business card (step 207). When a length of 148 mm is detected (YES at step 208), it is judged that the size of the document D is “A5-R” (step 209). When a length 182 mm is detected (YES at step 210), it is judged that the size of the document D is “B5-R” (step 211). When a length of 210 mm is detected (YES at step 212), subsequently, a detection processing of an edge covered with the black tape 62 is executed.

That is, in the detection processing of the edge covered with the black tape 62, when a length of 148 mm is detected (YES at step 213), it is judged that the size of the document D is “A5” (step 214). In the case where a length of 148 mm is not detected (NO at step 213), it is judged that the size of the document D is “A4-R” (step 215).

At step 212, also in the case where a length of 210 mm is not detected (NO at step 212), the detection processing of the edge covered with the black tape 62 is executed.

That is, in the detection processing of the edge covered with the black tape 62, when a length of 182 mm is detected (YES at step 216), it is judged that the size of the document D is “B5” (step 217). When a length of 210 mm is detected (YES at step 218), it is judged that the size of the document D is “A4” (step 219). When a length of 364 mm is detected (YES at step 220), it is judged that the size of the document D is “B4” (step 221). In the case where a length of 364 mm is not detected (NO at step 220), it is judged that the size of the document D is “A3” (step 222).

As described above, by sticking the black tapes 61 and 62 to the lower surface of the platen cover 3, the size of the document D set on the document table 2 can be inexpensively and accurately detected without using four or five expensive photosensors.

A second embodiment of the invention will be described with reference to the drawings. Incidentally, in the drawings, the same portions as those of the first embodiment are denoted by the same symbols, and their explanation will be omitted.

As shown in FIG. 11 and FIG. 12, instead of the black tapes 61 and 62 of the first embodiment, a black tape 63 as a band-like first black member and a black tape 64 as a band-like second black member are stuck to a lower surface (surface coming in contact with a document table 2 and a document D) 3a of a platen cover 3.

The black tape 63 is shorter than the black tape 61 by a length of, for example, 145 mm from a striking position of the document D in an edge 2a of the document table 2. The black tape 64 is also shorter than the black tape 62 by a length of, for example, 145 mm from a striking position of the document D in an edge 2b of the document table 2.

That is, 145 mm is a length shorter than the length of each edge of the documents D of “A5-R” size and “A5” size. That is, the black tapes 63 and 64 can always cover the respective edges of the documents D of all sizes. Thus, all the sizes of the documents D can be detected through the black tapes 63 and 64.

As described above, by sticking the black tapes 63 and 64 to the lower surface of the platen cover 3, the size of the document D set on the document table 2 can be inexpensively and accurately detected without using four or five expensive photosensors.

Incidentally, in the respective embodiments, although the black tape is used as the black member, limitation is not made to the tape, and a structure of printing black ink may be adopted. As long as optical reflectance different from that of the texture of the document D is obtained, in addition to black, a tape or ink of another color may be used.

Besides, in the respective embodiments, although the size of the document D is detected at the same time as the light exposure to read the image of the document D, a structure may be made such that light exposure to detect the size of the document D (so-called prescan) is performed before the light exposure to read the image of the document D.

Additional advantages and modifications will readily occur to those skilled in the art. Therefore, the invention in its broader aspects is not limited to the specific details and representative embodiments shown and described herein. Accordingly various modifications may be made without departing from the spirit or scope of the general inventive concept as defined by the appended claims and their equivalents.

What is claimed is:

1. An image forming apparatus comprising:
a document table on which a document is to be set;
a cover to press the document set on the document table;
a member provided on the cover and having optical reflectance different from that of a texture of the document;
a light exposure section to expose the document set on the document table and the member;
a detection section to detect at least one edge of the document set on the document table and a length of the edge according to an amount of reflected light from the document and that from the member at a time of the light exposure; and
a judgment section to judge a size of the document set on the document table according to a detection result of the detection section.

2. The apparatus according to claim 1, wherein the cover is openably/closably provided to the document table.

3. The apparatus according to claim 1, wherein the member is stuck to a surface of the cover which comes in contact with the document table and the document.

4. The apparatus according to claim 1, wherein the member is a band-like first black member and a band-like second black member provided to face band-like read ineffective areas along a first edge and a second edge with which the document set on the document table comes in contact among edges of the document table.

5. The apparatus according to claim 1, wherein the light exposure section performs main scanning to optically scan the document set on the document table and the member in one direction and performs sub-scanning in which the main scanning is shifted in a direction perpendicular to the one direction.

6. The apparatus according to claim 1, wherein the light exposure section includes:
a light exposure lamp to expose the document placed on the document table;
a carriage to reciprocate the light exposure lamp along the document table; and
a CCD that receives the reflected light from the document by the light exposure of the light exposure lamp performing main scanning of the light receiving area and sub-scanning in which the main scanning is repeated according to a forward movement of the light exposure lamp and that outputs signals of voltage levels corresponding to the amount of the reflected light from the document set on the document table and that from the member.

7. The apparatus according to claim 1, wherein the detection section detects at least the one edge of the document set on the document table and the length of the edge according to a difference between the amount of the reflected light from the document and the amount of the reflected light from the member at the time of the light exposure.

8. The apparatus according to claim 1, wherein the judgment section judges the size of the document set on the document table according to the length of the edge detected by the detection section.

9. The apparatus according to claim 1, further comprising:
a scanner to read an image of the document placed on the document table by the light exposure of the light exposure section; and
a printer to print the read image of the scanner onto a paper sheet.

10. An image forming apparatus comprising:
a document table on which a document is to be set;
a cover to press the document set on the document table;
a member provided on the cover and having optical reflectance different from that of a texture of the document;
light exposure means for exposing the document set on the document table and the member;
detection means for detecting at least one edge of the document set on the document table and a length of the edge according to an amount of reflected light from the document and that from the member at a time of the light exposure; and
judgment means for judging a size of the document set on the document table according to a detection result of the detection means.

11. The apparatus according to claim 10, wherein the cover is openably/closably provided to the document table.

12. The apparatus according to claim 10, wherein the member is stuck to a surface of the cover which comes in contact with the document table and the document.

13. The apparatus according to claim 10, wherein the member is a band-like first black member and a band-like second black member provided to face band-like read ineffective areas along a first edge and a second edge with which the document set on the document table comes in contact among edges of the document table.

14. The apparatus according to claim 10, wherein the light exposure means performs main scanning to optically scan the document set on the document table and the member in one direction and performs sub-scanning in which the main scanning is shifted in a direction perpendicular to the one direction.

15. The apparatus according to claim 10, wherein the light exposure section includes:
a light exposure lamp to expose the document placed on the document table;
a carriage to reciprocate the light exposure lamp along the document table; and
a CCD that receives the reflected light from the document by the light exposure of the light exposure lamp performing main scanning of the light receiving area and sub-scanning in which the main scanning is repeated according to a forward movement of the light exposure lamp and that outputs signals of voltage levels corresponding to the amount of the reflected light from the document set on the document table and that from the member.

16. The apparatus according to claim 10, wherein the detection section detects at least the one edge of the document set on the document table and the length of the edge according to a difference between the amount of the reflected light from the document and the amount of the reflected light from the member at the time of the light exposure.

17. The apparatus according to claim 10, wherein the judgment means judges a size of the document set on the document table according to the length of the edge detected by the detection section.

18. The apparatus according to claim 10, further comprising:
a scanner to read an image of the document placed on the document table by the light exposure of the light exposure means; and
a printer to print the read image of the scanner onto a paper sheet.

19. A control method of an image forming apparatus comprising a document table on which a document is to be set, a cover to press the document set on the document table, a member provided on the cover and having optical reflectance different from that of a texture of the document, and a light exposure section to expose the document set on the document table and the member, the method comprising:
detecting at least one edge of the document set on the document table and a length of the edge according to an amount of reflected light from the document and that from the member at a time of the light exposure; and
judging a size of the document set on the document table according to a result of the detection.
